(19) United States
(12) Patent Application Publication
(10) Pub. No.: US 2021/0184762 A1
(43) Pub. Date: Jun. 17, 2021

(54) COMMUNICATION TERMINAL AND CONTROL METHOD

(71) Applicant: Icom Incorporated, Osaka (JP)

(72) Inventors: Nobuki Saratani, Osaka (JP); Hiroyuki Adachi, Osaka (JP)

(21) Appl. No.: 17/078,757

(22) Filed: Oct. 23, 2020

(30) Foreign Application Priority Data
Dec. 11, 2019 (JP) 2019-224018

(51) Int. Cl. H04B 7/185; G08B 21/18

(52) U.S. Cl. CPC H04B 7/18513; G08B 21/182

(57) ABSTRACT

Realized is a communication terminal which, in a case where a status of communication with a low-earth-orbit satellite becomes poor, notifies a user that the status of the communication with the low-earth-orbit satellite is poor. A communication terminal includes: a determining section which determines whether or not an index satisfies a given condition, the index being calculated based on at least one of communication status information indicative of a status of communication between the communication terminal and a satellite, a status of decoding of a signal received from the satellite, and a status of readiness of voice communication based on the signal received from the satellite; and a notification control section which, in a case where the determining section determines that the index satisfies the given condition, controls a notification to be sent to a user of the communication terminal, the notification indicating that the index satisfies the given condition.

This Nonprovisional application claims priority under 35 U.S.C. § 119 on Patent Application No. 2019-224018 filed in Japan on Dec. 11, 2019, the entire contents of which are hereby incorporated by reference.

### TECHNICAL FIELD

The present invention relates to (i) a communication terminal which communicates with a satellite in a satellite communication system and (ii) a method for controlling the communication terminal.

### BACKGROUND ART

Patent Literature 1 discloses a radio terminal and the like used for a satellite radio terminal communication system. Patent Literature 1 also mentions a problem that, according to the satellite radio terminal communication system, satellite signals are likely to be blocked by high-rise buildings. Moreover, Patent Literature 1 discloses that it is possible to address the problem by terrestrially reusing a frequency band used for the satellite radio terminal communication system.

### CITATION LIST

### Patent Literature

[Patent Literature 1]
Published Japanese Translation of PCT International Application Tokuhyo No. 2007-533208

### SUMMARY OF INVENTION

### Technical Problem

According to a low-earth-orbit (LEO) satellite communication system, a satellite orbits, in a low earth orbit, the earth. Therefore, according to the technique disclosed in Patent Literature 1, it is not possible to sufficiently reduce an effect of a blocking object, such as a high-rise building, on satellite communication.

Furthermore, according to the low-earth-orbit satellite communication system, not only a small number of low-earth-orbit satellites (for example, a few low-earth-orbit satellites) are located within a range above the earth, which range is perceivable from a communication terminal present on the earth, but also respective locations of the low-earth-orbit satellites vary with each passing minute. Therefore, there often arises a possibility that the communication terminal cannot communicate with a low-earth-orbit satellite due to a blocking object such as a building and a mountain. However, since it is not possible for a user of the communication terminal to see a location of the low-earth-orbit satellite and, in addition, understand a status of a communication terminal on the other side, there is a problem that, in a case where a status of communication becomes poor, it is not possible for the user to find out which side (a user's side or the other side) has a cause.

An object of an aspect of the present invention is to realize a communication terminal and the like, each of which, in a case where a status of communication with a low-earth-orbit satellite becomes poor, notifies a user that the status of the communication with the low-earth-orbit satellite is poor.

### Solution to Problem

In order to attain the above object, a communication terminal in accordance with an aspect of the present invention is a communication terminal which is present on the earth and which has a function of communicating with a satellite included in a low-earth-orbit satellite communication system, including: a communication status obtaining section which obtains, from the satellite, communication status information indicative of a status of communication between the communication terminal and the satellite; a determining section which determines whether or not an index satisfies a given condition, the index being calculated based on at least one of the communication status information, a status of decoding of a signal received from the satellite, and a status of readiness of voice communication based on the signal received from the satellite, while a voice is being transmitted to the satellite; and a notification control section which, in a case where the determining section determines that the index satisfies the given condition, controls a notification to be sent to a user of the communication terminal, the notification indicating that the index satisfies the given condition.

A control method in accordance with an aspect of the present invention is a method for controlling a communication terminal which is present on the earth and which has a function of communicating with a satellite included in a low-earth-orbit satellite communication system, the method including: a communication status obtaining step of obtaining, from the satellite, communication status information indicative of a status of communication between the communication terminal and the satellite; a determining step of determining whether or not an index satisfies a given condition, the index being calculated based on at least one of the communication status information, a status of decoding of a signal received from the satellite, and a status of readiness of voice communication based on the signal received from the satellite, while a voice is being transmitted to the satellite; and a notifying step of, in a case where it is determined that the index satisfies the given condition, controlling a notification to be sent to a user of the communication terminal, the notification indicating that the index satisfies the given condition.

### Advantageous Effects of Invention

According to a communication terminal and the like in accordance with an aspect of the present invention, in a case where a status of communication with a low-earth-orbit satellite becomes poor, it is possible to notify a user that the status of the communication with the low-earth-orbit satellite is poor.

### BRIEF DESCRIPTION OF DRAWINGS

FIG. 1 is a schematic view illustrating an outline of a satellite communication system including a communication terminal in accordance with Embodiment 1.

FIG. 2 is a schematic view illustrating respective communication areas of satellites each of which communicates with the communication terminal in accordance with Embodiment 1.

FIG. 3 is a block diagram illustrating a configuration of a main part of the communication terminal in accordance with Embodiment 1.

FIG. 4 is a flowchart illustrating an example of a process by which the communication terminal in accordance with Embodiment 1 causes a display to display a direction of and a distance to a satellite.

FIG. 5 is a flowchart illustrating an example of a process by which a speaker is caused to output a beep in a case where a status of communication from the communication terminal in accordance with Embodiment 1 to the satellite becomes poor.

FIG. 6 is a block diagram illustrating a configuration of a main part of a communication terminal in accordance with Embodiment 2.

FIG. 7 is a block diagram illustrating a configuration of a main part of a communication terminal in accordance with Embodiment 3.

### DESCRIPTION OF EMBODIMENTS

### Embodiment 1

The following description will discuss an embodiment of the present invention in detail.

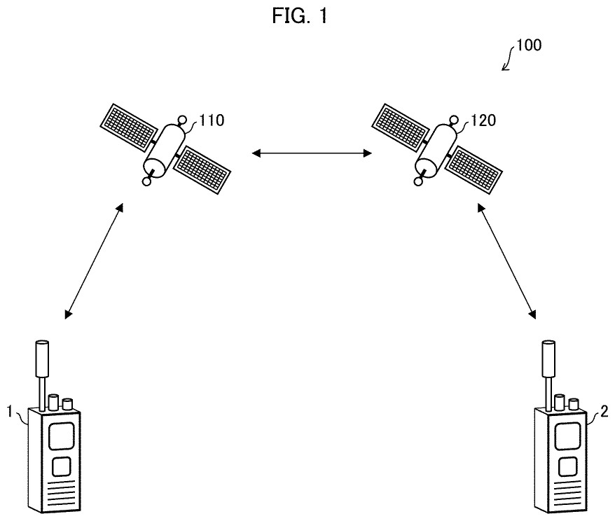

FIG. 1 is a schematic view illustrating an outline of a low-earth-orbit satellite communication system 100 including a communication terminal 1 in accordance with Embodiment 1. As illustrated in FIG. 1, the low-earth-orbit satellite communication system 100 includes a satellite 110, a satellite 120, the communication terminal 1, and a communication terminal 2. Note that the satellites 110 and 120 and the communication terminals 1 and 2 illustrated in FIG. 1 are part of the low-earth-orbit satellite communication system 100, and the low-earth-orbit satellite communication system 100 may include more satellites and more communication terminals.

Each of the satellites 110 and 120 is a low-earth-orbit satellite which is located not more than 2000 km above the earth's surface and which makes a circuit of the earth in approximately one to two hours. Each of the satellites 110 and 120 has a function of communicating with each of the communication terminals 1 and 2 and a function of communicating with the other one.

Each of the communication terminals 1 and 2 is a communication terminal which is present on the earth and which has a function of communicating with each of the satellites 110 and 120. Each of the communication terminals 1 and 2 conducts voice communication by a push-to-talk (PTT) method.

A case will be described in which, as illustrated in FIG. 1, the communication terminal 1 is acquiring the satellite 110 and the communication terminal 2 is acquiring the satellite 120. In this case, communication between the communication terminal 1 and the communication terminal 2 is realized by (i) the communication terminal 1 and the satellite 110 communicating with each other, (ii) the satellite 110 and the satellite 120 communicating with each other, and (iii) the satellite 120 and the communication terminal 2 communicating with each other. In short, according to the low-earth-orbit satellite communication system 100, the communication terminals 1 and 2 communicate with each other merely via the satellites 110 and 120, without use of a base station and the like on the earth.

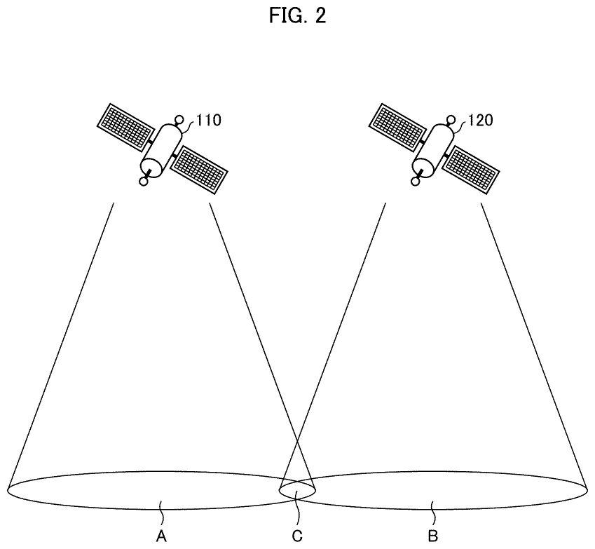

FIG. 2 is a schematic view illustrating respective communication areas of the satellites 110 and 120. The satellites 110 and 120 have communication areas A and B, respectively, each of which depends on a positional relationship with the earth. Each of the communication terminals 1 and 2 acquires and communicates with one of the satellites 110 and 120 which one corresponds to a communication area in which the each of the communication terminals 1 and 2 is present.

As illustrated in FIG. 2, the communication areas A and B have an overlapping area C in which the communication areas A and B overlap with each other. Therefore, each of the communication terminals 1 and 2 is capable of acquiring a plurality of satellites, depending on a location of the each of the communication terminals 1 and 2. Specifically, in a case where each of the communication terminals 1 and 2 is present in the overlapping area C, the each of the communication terminals 1 and 2 acquires one of the satellites 110 and 120 on the basis of intensity of a radio wave received from each of the satellites 110 and 120. And then, the each of the communication terminals 1 and 2 continues to acquire the one of the satellites 110 and 120, provided that it is determined that the intensity of the radio wave received from the one of the satellites 110 and 120, which one the each of the communication terminals 1 and 2 is acquiring, is sufficiently higher than the intensity of the radio wave received from the other of the satellites 110 and 120.

Note that, according to the low-earth-orbit satellite communication system 100, delay in communication is reduced, as compared with, for example, a satellite communication system which employs a satellite that is in a geostationary orbit (geostationary satellite). On the other hand, a frequency at which each of the communication terminals switches between the satellites to communicate with is increased due to movement of each of the satellites and/or movement of each of the communication terminals, because the respective communication areas of the satellites are small as compared with the geostationary satellite.

Note that, for convenience, merely the communication terminal 1 will be described below, unless particularly necessary. Note also that the following description will be given on the premise that the communication terminal 1 acquires the satellite 110.

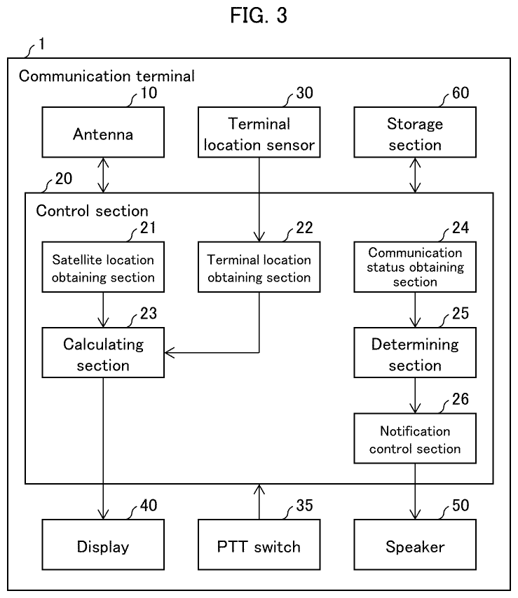

FIG. 3 is a block diagram illustrating a configuration of a main part of the communication terminal 1. As illustrated in FIG. 3, the communication terminal 1 includes an antenna 10, a control section 20, a terminal location sensor 30, a PTT switch 35, a display 40 (display device), a speaker 50, and a storage section 60. Furthermore, the communication terminal 1 has facilities which a communication terminal generally has, such as a microphone via which an input of a voice is accepted and a button via which an input operation is accepted.

The antenna 10 is an antenna for communication with the satellite 110. The antenna 10 may be a whip antenna or may be alternatively any other kind of antenna.

The terminal location sensor 30 is a sensor which detects a location of the communication terminal 1 on the earth. The terminal location sensor 30 is, for example, a global positioning system (GPS) sensor.

The PTT switch 35 is an operation section for transmission of a voice to the satellite 110. In a case where the PTT switch 35 is operated, the communication terminal 1 transmits, to the satellite 110 which the communication terminal 1 is acquiring, a signal which requires connection for voice communication. Then, in a case where the communication terminal 1 receives, from the satellite 110, a signal which approves the connection for the voice communication, the communication terminal 1 is brought into a state where the communication terminal 1 can transmit a voice. A voice inputted into the communication terminal 1 in this state is concurrently transmitted to, via the satellite 110, communication terminals included in a preset talk group.

Note that, in a case where the communication terminals 1 and 2 are included in an identical talk group, the satellite 110 controls the communication terminal 2 not to be brought into a state where the communication terminal 2 can transmit a voice even in a case where a PTT switch 35 of the communication terminal 2 is operated, while the PTT switch 35 of the communication terminal 1 is being operated. That is, a plurality of communication terminals included in an identical talk group are not simultaneously brought into a state where each of the plurality of communication terminals can transmit a voice.

The display 40 displays a direction of the satellite 110 with respect to the communication terminal 1, which direction is calculated by a calculating section 23 (later described). The display 40 is, for example, a liquid crystal display or an organic electroluminescence (EL) display. The speaker 50 is a voice outputting device. The storage section 60 is a storage device in which various pieces of information which are necessary for the control section 20 to control the communication terminal 1 are stored.

The control section 20 controls operation of the communication terminal 1. As illustrated in FIG. 3, the control section 20 includes a satellite location obtaining section 21, a terminal location obtaining section 22, the calculating section 23, a communication status obtaining section 24, a determining section 25, and a notification control section 26. The control section 20 has functions which a control section of a communication terminal generally has, such as a function for acquisition of a satellite and functions for voice communication (for example, an encoding function, a decoding function, and a session control function).

The satellite location obtaining section 21 obtains, from the satellite 110, information indicative of the location of the satellite 110 which the communication terminal 1 is acquiring (hereinafter, referred to as “satellite location information”) on a real-time basis (for example, every second). Further, the satellite location obtaining section 21 obtains, from the satellite 110, the satellite location information also in a case where the PTT switch 35 is operated. This allows the satellite location obtaining section 21 to obtain satellite location information on a satellite, which satellite location information is used for transmission of a voice, at a timing at which the transmission of the voice is started.

The terminal location obtaining section 22 obtains, from the terminal location sensor 30, information indicative of the location of the communication terminal 1 (hereinafter, referred to as “terminal location information”). A timing at which the terminal location obtaining section 22 obtains the terminal location information is not limited in particular, and may be identical to a timing at which the satellite location obtaining section 21 obtains the satellite location information.

The calculating section 23 calculates the direction of the satellite 110 with respect to the communication terminal from (i) the satellite location information which the satellite location obtaining section 21 has obtained and (ii) the terminal location information which the terminal location obtaining section 22 has obtained. As used herein, the “direction” may be merely a bearing on the earth's surface or may be alternatively a three-dimensional direction including an angle of elevation with respect to the earth's surface. The calculating section 23 controls the display 40 to display information indicative of the direction of the satellite 110 thus calculated. The information is displayed with use of at least any one of, for example, a character string and an image.

The calculating section 23 may further calculate a distance between the communication terminal 1 and the satellite 110 from (i) the satellite location information which the satellite location obtaining section 21 has obtained and (ii) the terminal location information which the terminal location obtaining section 22 has obtained, and may control the display 40 to display information indicative of the distance.

The communication status obtaining section 24 obtains, from the satellite 110, information indicative of a status of communication between the communication terminal 1 and the satellite 110 (hereinafter, referred to as “communication status information”). A preferable typical example of the communication status information is information indicative of intensity of a radio wave which the communication terminal 1 receives from the satellite 110. However, the communication status information is not limited to such information.

The determining section 25 calculates an index regarding the status of the communication between the communication terminal 1 and the satellite 110 on the basis of at least any one of (1) the communication status information which the communication status obtaining section 24 has obtained, (2) a status of decoding of a signal received from the satellite 110, and (3) a status of readiness of voice communication based on the signal received from the satellite 110 (hereinafter, referred to as a “communication index”), while a voice is being transmitted from the communication terminal 1 to the satellite 110. Note that, more specifically, the “status of decoding” in the above (2) indicates whether or not the signal received from the satellite 110 is in a state of being normally decoded. Note that, more specifically, the “status of readiness” in the above (3) indicates whether or not the voice communication is at a level at which the voice communication can be conducted on the basis of the signal received from the satellite 110.

The determining section 25 then determines whether or not the communication index satisfies a given condition. In a case where goodness of the status of the communication is proportional to the communication index, the determining section 25 can set, as the given condition, a condition that the communication index is less than a given threshold. The given threshold is preferably set to a value corresponding to a case where the status of the communication is so poor that a voice is difficult to catch with use of the communication terminal 1, because, for example, (1) the intensity of the radio wave is lower than a reference, (2) a decoding error rate is higher than a reference, or (3) the voice communication is not at a level at which the voice communication can be conducted.

In a case where the determining section 25 determines that the communication index satisfies the given condition, the notification control section 26 controls a notification to be sent to a user of the communication terminal 1, which notification indicating that the communication index satisfies the given condition. A typical example of a way in which the notification is sent by control by the notification control section 26 is output of a given beep by the speaker 50.

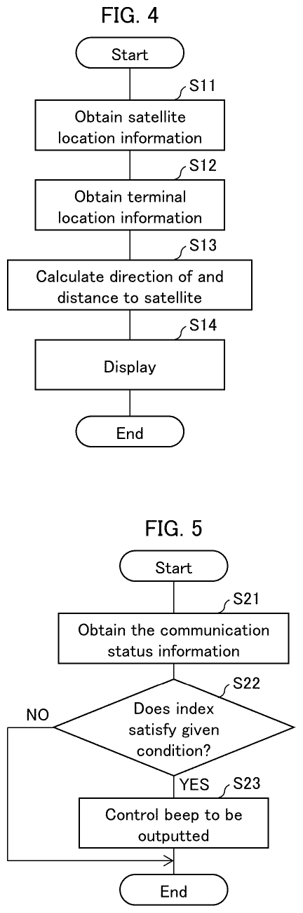

FIG. 4 is a flowchart illustrating an example of a process by which the communication terminal 1 causes the display 40 to display the direction of and the distance to the satellite 110 (control method). First, the satellite location obtaining section 21 obtains the satellite location information (S11, satellite location obtaining step). Next, the terminal location obtaining section 22 obtains the terminal location information (S12, terminal location obtaining step). Order in which S11 and S12 are carried out is not limited. S11 and S12 can be carried out simultaneously.

Subsequently, the calculating section 23 calculates the direction of and the distance to the satellite 110 with respect to the communication terminal 1 (S13, calculating step). Finally, the calculating section 23 controls the display 40 to display the direction of and the distance to the satellite 110 thus calculated (S14).

Note that, according to the example illustrated in FIG. 4, in S14, the calculating section 23 calculates the direction of and the distance to the satellite 110 and controls the display 40 to display the direction and the distance. However, as has been described, the calculating section 23 may calculate merely the direction of the satellite 110 and control the display 40 to display merely the direction.

FIG. 5 is a flowchart illustrating an example of a process by which the speaker 50 is caused to output the beep in a case where the status of the communication between the communication terminal 1 and the satellite 110 becomes poor. First, the communication status obtaining section 24 obtains the communication status information from the satellite 110 (S21, communication status obtaining step). Next, the determining section 25 calculates the communication index and determines whether or not the communication index satisfies the given condition (S22, determining step). In a case where the communication index satisfies the given condition (YES, in S22), the notification control section 26 controls the speaker 50 to output the beep (S23, notifying step). In a case where the communication index does not satisfy the given condition (NO, in S22), the process is ended.

(Effects)

Generally, according to a satellite communication system, it is important that no blocking object be present between a satellite and a communication terminal, in order that a status of communication is good. However, according to a conventional communication terminal, it is not possible to understand a location of a satellite which the conventional communication terminal is acquiring. Therefore, in a case where a status of communication becomes poor in a situation where, for example, high-rise buildings or mountains, each of which can be a blocking object, are present near the conventional communication terminal, it is not possible for a user to understand which of the high-rise buildings or the mountains is a blocking object.

In this case, it is possible to check the location of the satellite with use of a smartphone application and the like. However, in a situation in which a satellite communication system is used, it is not always possible for a smartphone to conduct communication. Furthermore, from the viewpoint of user's convenience, it is preferable that the location of the satellite can be checked without combination use of a device other than the communication terminal.

In contrast, according to the communication terminal 1, it is possible for the user to understand, on a real-time basis, the direction of the satellite 110 which the communication terminal 1 is acquiring. In a case where it is possible for the user to understand the direction of the satellite 110, it is possible for the user to understand whether or not a blocking object is present between the communication terminal 1 and the satellite 110 and, accordingly, to take action, for example, move a location of the user himself/herself.

Furthermore, according to the communication terminal 1, in a case where the communication index satisfies the given condition, that is, in a case where the status of the communication from the communication terminal 1 to the satellite 110 becomes poor, the user is notified that the status of the communication from the communication terminal 1 to the satellite 110 is poor. Therefore, in a case where the status of the communication is poor, it is possible for the user to recognize that what causes the status of the communication to be poor lies on a user's side. Accordingly, it is possible for the user to relieve stress resulting from the fact that what causes the status of the communication to be poor is not clear.

Moreover, in a case where the user understands that a blocking object is present between the communication terminal 1 and the satellite 110, it is possible for the user to take action, for example, move the location of the user himself/herself.

Furthermore, according to the communication terminal 1, the beep is outputted. Therefore, even in a case where the user operates the communication terminal 1 without checking the display 40, it is possible to give an opportunity to check the display 40.

Note that, according to the above-described example, the calculating section 23 controls the display 40 to display the direction of the satellite 110. However, the communication terminal 1 is not limited to such a configuration. The calculating section 23 may control the speaker 50 to output a voice indicating the direction, while or instead of controlling the display 40 to display the direction of the satellite 110.

Further, according to the above description, in a case where the status of the communication between the communication terminal 1 and the satellite 110 becomes poor, the notification control section 26 controls the speaker 50 to output the beep. However, the communication terminal 1 is not limited to such a configuration. The notification control section 26 may control the display 40 to display a notification indicating that the status of the communication is poor, while or instead of controlling the speaker 50 to output the beep.

### Embodiment 2

Embodiment 2 of the present invention will be described below. Note that, for convenience, members having functions identical to those of members described in Embodiment 1 will be given identical reference signs.

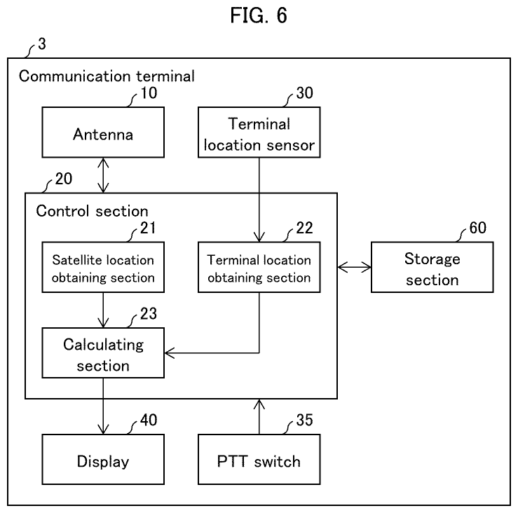

FIG. 6 is a block diagram illustrating a configuration of a main part of a communication terminal 3 in accordance with Embodiment 2. As illustrated in FIG. 6, a control section 20 of the communication terminal 3 includes a satellite location obtaining section 21, a terminal location obtaining section 22, and a calculating section 23, but does not include a communication status obtaining section 24, a determining section 25, and a notification control section 26.

The communication terminal 3 also allows a user to understand, on a real-time basis a direction of a satellite 110 which the communication terminal 3 is acquiring. Therefore, in a case where a blocking object is present between the communication terminal 3 and the satellite 110, it is possible for the user to take action, for example, move a location of the user himself/herself so that communication is not blocked by the blocking object.

### Embodiment 3

Embodiment 3 of the present invention will be described below. Note that, for convenience, members having functions identical to those of members described in Embodiments 1 and 2 will be given identical reference signs.

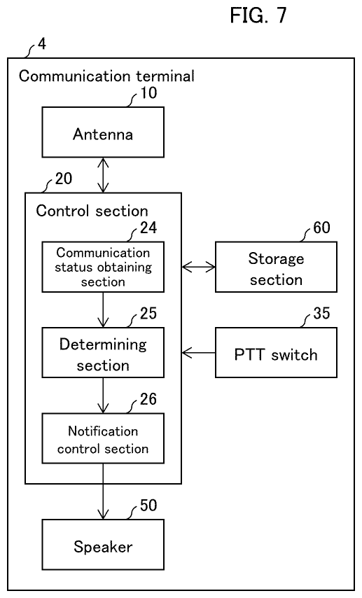

FIG. 7 is a block diagram illustrating a configuration of a main part of a communication terminal 4 in accordance with Embodiment 3. As illustrated in FIG. 7, a control section 20 of the communication terminal 4 includes a communication status obtaining section 24, a determining section 25, and a notification control section 26, but does not include a satellite location obtaining section 21, a terminal location obtaining section 22, and a calculating section 23.

The communication terminal 4 is also configured such that, in a case where a status of communication between the communication terminal 4 and a satellite 110 becomes poor, the communication terminal 4 notifies, by a beep, a user that the status of the communication is poor. Accordingly, it is possible for the user to understand that the status of the communication is poor. Therefore, according to the communication terminal 4, it is possible to reduce stress resulting from the fact that what causes the status of the communication to be poor is not clear.

### Software Implementation Example

Control blocks (particularly, the satellite location obtaining section 21, the terminal location obtaining section 22, the calculating section 23, the communication status obtaining section 24, the determining section 25, and the notification control section 26) of each of the communication terminals 1 through 4 can be realized by a logic circuit (hardware) provided in an integrated circuit (IC chip) or the like or can be alternatively realized by software.

In the latter case, each of the communication terminals 1 through 4 includes a computer that executes instructions of a program that is software realizing the foregoing functions. The computer, for example, includes at least one processor and a computer-readable storage medium in which the program is stored. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

Aspects of the present invention can also be expressed as follows:

A communication terminal in accordance with a first aspect of the present invention is a communication terminal which is present on the earth and which has a function of communicating with a satellite included in a low-earth-orbit satellite communication system, including: a communication status obtaining section which obtains, from the satellite, communication status information indicative of a status of communication between the communication terminal and the satellite; a determining section which determines whether or not an index satisfies a given condition, the index being calculated based on at least one of the communication status information, a status of decoding of a signal received from the satellite, and a status of readiness of voice communication based on the signal received from the satellite, while a voice is being transmitted to the satellite; and a notification control section which, in a case where the determining section determines that the index satisfies the given condition, controls a notification to be sent to a user of the communication terminal, the notification indicating that the index satisfies the given condition.

According to the above configuration, the index is calculated based on at least one of the communication status information received from the satellite, the status of the decoding of the signal received from the satellite, and the status of the readiness of the voice communication based on the signal received from the satellite, while the voice is being transmitted from the communication terminal to the satellite. In a case where the index thus calculated satisfies the given condition, the user of the communication terminal is notified that the index satisfies the given condition. It is therefore possible for the user to easily recognize that the index satisfies the given condition.

The communication terminal in accordance with a second aspect of the present invention is preferably arranged such that, in the first aspect, the communication status obtaining section obtains, as the communication status information, intensity of a radio wave which the communication terminal receives from the satellite.

According to the above configuration, it is possible for the determining section to calculate the index on the basis of the intensity of the radio wave received from the satellite. By calculating the index on the basis of the intensity of the radio wave, it is possible to increase accuracy of the index.

The communication terminal in accordance with a third aspect of the present invention is preferably arranged so as to, in the first or second aspect, further include: a satellite location obtaining section which obtains, from the satellite, satellite location information indicative of a location of the satellite which the communication terminal is acquiring; a terminal location obtaining section which obtains terminal location information indicative of a location of the communication terminal; and a calculating section which calculates, from the satellite location information and the terminal location information, a direction of the satellite with respect to the communication terminal.

According to the above configuration, it is possible for the user of the communication terminal to easily recognize, as information on the status of the communication, the direction of the satellite which the communication terminal is acquiring. Therefore, in a case where a blocking object is present in the direction of the satellite which the communication terminal is acquiring, it is possible for the user to take action, for example, move a location of the user himself/herself.

The communication terminal in accordance with a fourth aspect of the present invention is preferably arranged so as to, in the third aspect, further include a display device which displays the direction that the calculating section has calculated.

According to the above configuration, it is possible for the user to easily recognize the direction of the satellite with respect to the communication terminal, merely by checking the display device.

The communication terminal in accordance with a fifth aspect of the present invention is preferably arranged so as to, in the third or fourth aspect, further include a PTT switch which is for transmission of the voice to the satellite, the satellite location obtaining section obtains the satellite location information in a case where the PTT switch is operated.

According to the above configuration, the satellite location obtaining section obtains the satellite location information in a case where the PTT switch is operated. It is therefore possible to obtain the satellite location information on the satellite, which satellite location information is used for the transmission of the voice, at a timing at which the user starts the transmission of the voice.

A control method in accordance with a sixth aspect of the present invention is a method for controlling a communication terminal which is present on the earth and which has a function of communicating with a satellite included in a low-earth-orbit satellite communication system, the method including: a communication status obtaining step of obtaining, from the satellite, communication status information indicative of a status of communication between the communication terminal and the satellite; a determining step of determining whether or not an index satisfies a given condition, the index being calculated based on at least one of the communication status information, a status of decoding of a signal received from the satellite, and a status of readiness of voice communication based on the signal received from the satellite, while a voice is being transmitted to the satellite; and a notifying step of, in a case where it is determined that the index satisfies the given condition, controlling a notification to be sent to a user of the communication terminal, the notification indicating that the index satisfies the given condition.

According to the above configuration, an effect is brought about which is similar to that brought about by the communication terminal in accordance with the first aspect.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 2, 3, 4 Communication terminal
21 Satellite location obtaining section
22 Terminal location obtaining section
23 Calculating section
24 Communication status obtaining section
25 Determining section
26 Notification control section
35 PTT switch
40 Display (display device)
100 Low-earth-orbit satellite communication system
110, 120 Satellite

1. A communication terminal which is present on the earth and which has a function of communicating with a satellite included in a low-earth-orbit satellite communication system, comprising:
a communication status obtaining section which obtains, from the satellite, communication status information indicative of a status of communication between the communication terminal and the satellite;
a determining section which determines whether or not an index satisfies a given condition, the index being calculated based on at least one of the communication status information, a status of decoding of a signal received from the satellite, and a status of readiness of voice communication based on the signal received from the satellite, while a voice is being transmitted to the satellite; and
a notification control section which, in a case where the determining section determines that the index satisfies the given condition, controls a notification to be sent to a user of the communication terminal, the notification indicating that the index satisfies the given condition.

2. The communication terminal as set forth in claim 1, wherein the communication status obtaining section obtains, as the communication status information, intensity of a radio wave which the communication terminal receives from the satellite.

3. The communication terminal as set forth in claim 1, further comprising:
a satellite location obtaining section which obtains, from the satellite, satellite location information indicative of a location of the satellite which the communication terminal is acquiring;
a terminal location obtaining section which obtains terminal location information indicative of a location of the communication terminal; and
a calculating section which calculates, from the satellite location information and the terminal location information, a direction of the satellite with respect to the communication terminal.

4. The communication terminal as set forth in claim 3, further comprising a display device which displays the direction that the calculating section has calculated.

5. The communication terminal as set forth in claim 3, further comprising
a PTT switch which is for transmission of the voice to the satellite,
the satellite location obtaining section obtaining the satellite location information in a case where the PTT switch is operated.

6. A method for controlling a communication terminal which is present on the earth and which has a function of communicating with a satellite included in a low-earth-orbit satellite communication system, the method comprising:
a communication status obtaining step of obtaining, from the satellite, communication status information indicative of a status of communication between the communication terminal and the satellite;
a determining step of determining whether or not an index satisfies a given condition, the index being calculated based on at least one of the communication status information, a status of decoding of a signal received from the satellite, and a status of readiness of voice communication based on the signal received from the satellite, while a voice is being transmitted to the satellite; and
a notifying step of, in a case where it is determined that the index satisfies the given condition, controlling a notification to be sent to a user of the communication terminal, the notification indicating that the index satisfies the given condition.
